(19) United States
(12) Patent Application Publication
(10) Pub. No.: US 2001/0031904 A1
(43) Pub. Date: Oct. 18, 2001

(54) Compositions and methods to reduce the volatility of radioactive waste

(76) Inventor: Mark Fitchmun, San Diego, CA (US)

Correspondence Address: PATENT SOLUTIONS, 11404 SORRENTO VALLEY ROAD, SUITE 104, SAN DIEGO, CA, 92121, US

(21) Appl. No.: 09/733,436

(22) Filed: Dec. 8, 2000

Related U.S. Application Data
(60) Provisional application No. 60/171,999, filed on Dec. 23, 1999.

(51) Int. Cl. G21F 9/00; B01J 20/22; B01J 20/02

(52) U.S. Cl. 588/1; 502/416; 502/401

(57) ABSTRACT

The present invention provides a device, compositions and methods for reducing the volatility of radioactive waste comprising; a receptacle having an open end said open end having a means for affixing a lid securely to said receptacle, a absorbent matrix comprising a humectant, a pH-stabilizing agent and an adsorbent material said matrix insertable into said receptacle and a lid for sealing the receptacle. Radioactive waste is deposited into the receptacle during use and the receptacle is sealed and disposed of safely.

A kit is also provided containing at least one of the devices of the invention to reduce the volatility of radioactive waste.

### CROSS-REFERENCE TO RELATED APPLICATIONS

This application is a continuation-in-part patent application of provisional patent application 60/171,999 filed Dec. 23, 1999.

### TECHNICAL FIELD

The present invention relates generally to the field of radiation safety, more specifically to procedures for safely handling and disposing of radioactive waste.

### BACKGROUND OF THE INVENTION

Solutions containing the radioactive salts, sodium iodide Na ¹²⁵I and Na¹³¹I, are commonly used to label tyrosine and histidine residues on proteins and peptides (Schuhmacher and Tsomides “In vitro labeling of peptides and proteins” pg. 3.3.1-3.3.19 Current Protocols in Protein Science, John Wiley and Sons Inc. Eds, 1995). The resulting labeled molecules, although radioactive and requiring appropriate handling precautions are relatively safe to work with. On the other hand, labeling requires reagents and creates waste solutions, which contain free iodide, I⁻. These liquids are more hazardous (Galanek Occup. Med. 2:225-69, 1991 and Lunn and Sansone, J. Chem. Educ. 71:972,1994).

Waste containing free iodide poses several risks: 1) Being a liquid, spills can result from handling or compromised containers; 2) Free iodine, I₂, which is continuously generated through the oxidation of iodide is highly reactive and can become incorporated into surfaces which it contacts, making effective decontamination difficult; and 3) Once generated, free iodine has an appreciable vapor pressure, and as a radioactive gas poses a significant contamination hazard to personnel as well as radiation sensitive equipment such as scintillation counters.

### SUMMARY OF THE INVENTION

In one embodiment of the present invention a device is provided that reduces the volatility of radioactive waste comprising a receptacle having an open end said open end having a means for affixing a lid securely to said receptacle, an absorbent matrix, comprising a humectant, a pH-stabilizing agent and an adsorptive material, said matrix insertable into said receptacle and a lid.

The receptacle may be constructed of one or more of a variety of materials for example, metal, ceramic, glass or plastic. Preferably the receptacle is constructed of plastic. The adsorbent matrix may be constructed of one or more natural materials, one or more synthetic materials or a combination of natural and synthetic materials. Natural materials include for example, cotton, wool, paper, diatomaceous earth, vermiculite and starch. Synthetic materials include fiberglass, cellulose derivatives, dextrans, polyacrylamide, or other hydrophilic polymers. Most preferably the adsorbent matrix is constructed of unidirectional cotton fibers. The pH-stabilizing agent may be composed of a variety of compounds or combinations of compounds including TRIS, dibasic phosphate salts, tribasic phosphate salts, sodium borate, the sodium salt of glycine, potassium acetate, or potassium hydroxide. Preferably the pH-stabilizing agent is composed of disodium phosphate. The adsorbent material is may be a variety of materials or combinations of materials, for example activated charcoal, starch, polymeric resins. Preferably the adsorbent material is activated charcoal.

In another embodiment of the invention a composition is provided comprising an absorbent matrix comprising a humectant, a pH-stabilizing agent, and an adsorbent material. The absorbent matrix comprising about 3 to about 20 parts glycerol, about 1 to about 10 parts disodium phosphate buffer solution and about 0.5 to about 10 parts activated charcoal. Preferably the matrix comprises 10 parts glycerol, 1 part disodium phosphate and 3 parts activated charcoal.

In another embodiment of the invention methods are provided for reducing the volatility of radioactive waste using the device above comprising the steps of inserting an absorbent matrix, comprising a humectant, a pH-stabilizing agent, and an adsorbent material into a receptacle, depositing a radioactive waste into the receptacle and sealing the receptacle with a lid.

In yet another embodiment of the invention a kit for reducing the volatility of radioactive waste is provided comprising; at least one receptacle having an open end said open end having a means for affixing a lid securely to the receptacle, at least one absorbent matrix, comprising a humectant, a pH-stabilizing agent, and an adsorbent material that may be inserted into the receptacle and at least one lid.

### DETAILED DESCRIPTION OF THE INVENTION

Prior to setting forth the invention, it may be helpful to an understanding thereof to first set forth definitions of certain terms that will be used herein after. These terms will have the following meanings unless explicitly stated otherwise:

The term “receptacle” as used herein refers to any container that is able to hold fluids.

The term “absorbent matrix” as used herein refers to any material that can take up or absorb liquid.

The term “pH-stabilizing agent” as used herein refers to any agent that acts to maintain the pH of a liquid above a desired pH.

The term “adsorbent material” as used herein refers to any material that immobilizes the radioactive waste.

The present invention provides a device that reduces the volatility of radioactive waste when such waste is deposited in the device. The device comprises an absorbent matrix and a humectant; or an absorbent matrix, a pH-stabilizing agent and an adsorptive material; or an absorbent matrix, a humectant and an adsorptive material; or an absorbent matrix a humectant, a pH-stabilizing agent, and an adsorptive material. Preferably, the device comprises a receptacle having an open end wherein the open end has a means for affixing a lid securely to the receptacle, an absorbent matrix, a humectant, a pH-stabilizing agent, an adsorptive material and a lid.

The receptacle is a container able to hold a liquid and having at least one opening and of a volume capacity necessary for accepting a desired amount of waste. The receptacle may be formed in a variety of shapes, including for example, cylindrical, conical, cubical, rectangular box or any combination of shapes and may be constructed of a variety of materials including plastic, glass, metal, ceramic or any combination thereof. The shape and size selected will depend on the volume of the waste for disposal, for example, if the amount of waste for disposal is a few milliliters then the receptacle may be of a size and shape that permits ease of use on a table top such as a cylindrical or conical shape acceptable for placement in a test tube or similar rack. Correspondingly, if the amount of waste for disposal is more than a liter the receptacle may be of a size able to hold such a volume and shaped with a handle for ease of transport. One skilled in the art would recognize that there are a large variety of sizes and shapes that may be utilized base on the needs of the user.

As previously stated the receptacle may be constructed of a variety of materials. One skilled in the art would recognize that the selection of material will depend on the type of waste to be deposited in the receptacle. For example, if organic solvents are used it may be preferable to utilize glass, ceramic or solvent resistant plastic materials. In addition, a shatter or break resistant material is preferable. Most preferably the material is a break resistant plastic.

The receptacle has at least one open end wherein the open end has a means for affixing a lid securely to the receptacle. The lid may be affixed to the receptacle by a variety of means including screw threads, a snap connection or a locking twist connection. One skilled in the art would recognize that the lid affixing means must safely secure the contents of the receptacle from spillage. Consequently, any means that satisfies this criterion could be used in the present invention.

The device may also comprise an absorbent matrix that takes up or absorbs the waste deposited in the receptacle. This material may be constructed of one or more natural, synthetic or a combination of both natural and synthetic materials. More specifically, if the material is natural it may be constructed of, for example, cotton, wool, paper, starch, vermiculite, or diatomaceous earth. If the material is synthetic it may be constructed of, for example, fiberglass, dextran, polyacrylamide, cellulose derivative, or synthetic hydrophilic polymers. Preferably the absorbent material is constructed of cotton. Most preferably the absorbent material is constructed of unidirectional cotton fibers. Some absorbent materials expand when they absorb liquids. When considering such expansion it is preferable that that expansion is directed toward the walls of the receptacle as opposed to the opening of the receptacle. For example, if the absorbent matrix is cotton it is preferable that the matrix comprise aligned cotton fibers to limit or control the direction of expansion. When the matrix is inserted into the receptacle the cotton fibers are aligned parallel to the receptacle walls thereby directing expansion against the walls. This is particularly preferable when other materials, such as pipet tips, utilized to dispense the radioactive waste are deposited in the receptacle. When expansion occurs the pipet tips are pushed against the walls of the receptacle and not ejected out the opening of the receptacle. Those skilled in the art will recognize that any material that is capable of absorbing and retaining the waste liquid deposited in the receptacle and can reduce spillage if the receptacle is damaged will be useful in the present invention.

The device may also comprise a humectant that acts to reduce the volatility of the radioactive waste or the mobility of particulates that might be introduced or form in the receptacle. A variety of humectants may be utilized in the present invention including for example, glycerol, polysorbates and calcium chloride hexahydrate. Most preferably the humectant is glycerol. Those skilled in the art would recognize that any humectant that reduces the volatility of the radioactive waste or mobility of particulates in the receptacle would be useful in the present invention.

The device may also comprise a pH-stabilizing agent that maintains the pH above a desired level. This is extremely important to prevent the formation of radioactive gas that can be formed under acidic conditions. A variety of buffering agents may be utilized in the present invention including for example, TRIS, dibasic phosphonate salts, tribasic phosphonate salts, sodium borate, the sodium salt of glycine, potassium acetate, and potassium hydroxide. Most preferably the pH-stabilizing agent is disodium phosphonate. Those skilled in the art would recognize that any pH-stabilizing agent that maintains the pH at a desired level in the receptacle would be useful in the present invention.

The device may also comprise an adsorptive material that immobilizes the radioactive waste on the surface of the material. This is important to reduce the escape of radioactive gas in the event of its formation as well as the spread of waste if the receptacle were damaged. A variety of adsorptive materials may be utilized in the present invention including for example, activated charcoal, starch, polymeric resins. Most preferably the adsorptive material is activated charcoal. Those skilled in the art would recognize that any adsorptive material that is able to immobilize the radioactive waste would be useful in the present invention.

The lid may be formed in a variety of shapes and sizes and may be constructed of a variety of materials. One skilled in the art would recognize that there are a large variety of shapes and sizes that may be utilized to form the lid and that the lid may further comprise a means for gripping the lid, such means may include any textured surface that increases friction enabling the user to securely affix the lid to the receptacle. One skilled in the art would also recognize that the selection of material used to form the lid will depend on the type of waste to be deposited in the receptacle. For example, if organic solvents are used it may be preferable to utilize glass, ceramic or solvent resistant plastic materials. Correspondingly, if the waste material is an aqueous solution a break resistant plastic may be preferable.

The receptacle has at least one open end wherein the open end has a means for affixing a lid securely to the receptacle. The lid may be affixed to the receptacle by a variety of means including screw threads, a snap connection or a locking twist connection. One skilled in the art would recognize that the lid affixing means must safely secure the contents of the receptacle from spillage. Consequently, any means that satisfies this criterion could be used in the present invention.

The following examples are provide by way of illustration and not by way of limitation.

### EXAMPLES

### Example 1

To test the effectiveness of this device in reducing the liberation of iodine gas, iodine levels in the headspace of the device were measured 24 hours following the introduction of Na¹²⁵I in solution. An o.b. Brand super absorbency tampon (Personal Products Co., Skillman, N.J.), was dipped into a mixture consisting of 10 parts glycerol, 3 parts charcoal, and one part disodium phosphate, and then placed into a 50 ml conical bottom tube. Control tubes were left empty. To each tube 10 ml of a solution containing 20 mM sodium acetate, pH 5.0 and 200 μCi of Na¹²⁵I was added. Next, a pipet tip with an aerosol guard was packed with 120 mg of activated charcoal and suspended in the headspace of each tube using a paperclip. The tubes were then sealed and allowed to stand at room temperature. After 24 hours the pipet tips containing the activated charcoal were collected and placed into glass test tubes for gamma counting.

A typical result obtained from one of several experiments was as follows: The median CPM in the headspace of tubes (n=2) containing absorbent was 6905 (range 5871 to 7939) whereas the median CPM in the headspace of tubes without absorbent was 2894012 (range 2706275 to 3081748). This translated to a 419-fold reduction in the levels of radioactive iodine gas when the waste was absorbed to the cotton plug/charcoal/glycerol device. Additionally, the entire 10 volume of radioactive solution was quickly absorbed thereby greatly diminishing the risk of accidental contamination. In this state the contents of the container can safely decay until radiation levels are sufficiently reduced to allow disposal.

This convenient and inexpensive method may be used to solidify and reduce the volatility of radioactive waste generated in the iodination of proteins and other molecules.

1. A device that reduces the volatility of radioactive waste comprising:
(a) a receptacle having an open end said open end having a means for affixing a lid securely to said receptacle,
(b) a absorbent matrix comprising a humectant, a pH-stabilizing agent and an adsorbent material said matrix insertable into said receptacle and
(c) A lid.

2. A device according to claim 1 wherein said radioactive waste comprises a radioactive isotope selected from the group consisting of ¹²⁵I and ¹³¹I.

3. A device according to claim 1 wherein said radioactive waste comprises a radioactive isotope selected from the group consisting of ³⁶CI, ³³P, ³²P, ³⁵S, ¹⁸F, ¹⁵O, ¹⁴C, ¹³N, ¹¹C, and ³H.

4. A device according to claim 1 wherein said receptacle is constructed of one or more of the materials selected from the group consisting of metal, ceramic, plastic and glass.

5. A device according to claim 1 wherein said receptacle is constructed of a plastic.

6. A device according to claim 1 wherein said absorbent matrix is constructed of one or more natural materials, one or more synthetic materials or a combination of one or more natural and one or more synthetic materials.

7. A device according to claim 5 wherein said natural material is selected from the group consisting of cotton, wool, paper, vermiculite, starch and diatomaceous earth.

8. A device according to claim 5 wherein said synthetic material is selected from the group consisting of fiberglass, cellulose derivatives, dextrans, polyacrylamide and hydrophilic polymers.

9. A device according to claim 1 wherein said absorbent matrix is constructed of unidirectional cotton fibers.

10. A device according to claim 1 wherein said pH-stabilizing agent is prepared from one or more of the following compounds selected from the group consisting of TRIS, dibasic phosphonate salts, tribasic phosphonate salts, sodium borate, the sodium salt of glycine, potassium acetate and potassium hydroxide.

11. A device according to claim 1 wherein said pH-stabilizing agent is dibasic phosphonate salts.

12. A device according to claim 1 wherein said adsorbent material is starch or polymeric resins.

13. A device according to claim 1 wherein said adsorbent material is activated charcoal.

14. A composition comprising an absorbent matrix, a humectant, a pH-stabilizing agent and adsorbent material.

15. A composition according to claim 14 wherein the absorbent matrix is constructed of unidirectional cotton fibers.

16. A composition according to claim 14 wherein the humectant is glycerol.

17. A composition according to claim 14 wherein the pH-stabilizing agent is composed of dibasic phosphonate salts.

18. A composition according to claim 14 wherein the adsorbent material is activated charcoal.

19. A composition according to claim 14 wherein the absorbent matrix contains about 3 to about 20 parts glycerol, about 1 to about 10 parts of a compositions of disodium phosphonate salts and about 0.5 to about 10 parts activated charcoal.

20. A method of reducing the volatility of radioactive waste using the device of claim 1 comprising the steps of:
(a) inserting a absorbent matrix containing a humectant, a pH-stabilizing agent and an adsorbent material into a receptacle,
(c) depositing a radioactive waste into said receptacle and
(b) sealing said receptacle with a lid.

21. A kit for reducing the volatility of radioactive waste comprising:
(a) at least one receptacle having an open end said open end having a means for affixing a lid securely to a receptacle,
(b) at least one absorbent matrix comprising a humectant, a pH-stabilizing agent and an adsorbent material that may be inserted into said receptacle and
(c) at least one lid.
